(19) United States
(12) Patent Application Publication
(10) Pub. No.: US 2016/0261576 A1
(43) Pub. Date: Sep. 8, 2016

(54) METHOD, AN APPARATUS, A COMPUTER PROGRAM PRODUCT AND A SERVER FOR SECURE ACCESS TO AN INFORMATION MANAGEMENT SYSTEM

(71) Applicant: M-Files Oy, Tampere (FI)

(72) Inventors: Antti Nivala, Pirkkala (FI); Paivi Yli-Olli, Tampere (FI)

(21) Appl. No.: 14/639,214

(22) Filed: Mar. 5, 2015

(51) Int. Cl. H04L 29/06

(52) U.S. Cl. CPC H04L 63/08; H04L 63/062; H04L 63/102

(57) ABSTRACT

The invention relates to a method and an apparatus, wherein the method comprises generating a request to access an information management system; including a secure key to the request, wherein the secure key has been obtained from a resource having an application-specific format, which application-specific format corresponds to the information management system; and sending the request. Further, the invention relates to a method and an apparatus for distributing the resource from an information management system and for receiving a request to access the information management system.

### TECHNICAL FIELD

The present application relates to an information management system. In particular, the present application relates to secure access to an information management system.

### BACKGROUND OF THE INVENTION

Enterprise Information Management (EIM) system refers to a system organizing and storing organization's electronic content, such as documents and other business-related objects, and/or structural data. EIM system may comprise enterprise content management (ECM) systems, content management systems (CMS), document management systems (DMS) and data management systems. Such systems comprise various features for managing electronic content, e.g. storing, versioning, indexing, searching for and retrieval of documents or other electronic objects, and for defining structural data. It is appreciated that there are both dynamic and static information management systems. The difference between dynamic and static systems is the way they store files. In static systems, the files are stored e.g. in a constant treelike hierarchy that defines relationships for folders and documents stored in the tree. In dynamic systems, the files may be given identifications that define their existence in the system. The location of the files is not constant, but may vary in a virtual space depending on the situation.

### SUMMARY OF THE INVENTION

Now there has been invented an improved method and technical equipment implementing the method. Various aspects of the invention include a method, an apparatus, a server, a client and a computer readable medium comprising a computer program stored therein, which are characterized by what is stated in the independent claims. Various embodiments of the invention are disclosed in the dependent claims.

According to a first aspect, there is provided a method comprising generating a request to access an information management system; including a secure key to the request, wherein the secure key has been obtained from a resource having an application-specific format, which application-specific format corresponds to the information management system; and sending the request.

According to a second aspect, there is provided an apparatus comprising at least one processor, memory including computer program code, the memory and the computer program code configured to, with the at least one processor, cause the apparatus to perform at least the following: generate a request to access an information management system; include a secure key to the request, wherein the secure key has been obtained from a resource having an application-specific format, which application-specific format corresponds to the information management system; and send the request.

According to a third aspect, there is provided a computer program product embodied on a non-transitory computer readable medium, comprising computer program code configured to, when executed on at least one processor, cause an apparatus to: generate a request to access an information management system; include a secure key to the request, wherein the secure key has been obtained from a resource having an application-specific format, which application-specific format corresponds to the information management system; and send the request.

According to a fourth aspect, there is provided a method, comprising receiving a request to access an information management system from a client device; detecting a secure key from the request; authenticating the secure key, wherein the authentication comprises determining whether the secure key matches with a secure key that has been distributed to the client device in a resource having an application-specific format, which application-specific format corresponds to the information management system.

According to a fifth aspect, there is provided a server comprising at least one processor, memory including computer program code, the memory and the computer program code configured to, with the at least one processor, cause the apparatus to perform at least the following: receive a request to access an information management system from a client device; detect a secure key from the request; authenticate the secure key, wherein the authentication comprises to determine whether the secure key matches with a secure key that has been distributed to the client device in a resource having an application-specific format, which application-specific format corresponds to the information management system.

According to a sixth aspect, there is provided a computer program product embodied on a non-transitory computer readable medium, comprising computer program code configured to, when executed on at least one processor, cause a system to receive a request to access an information management system from a client device; detect a secure key from the request; authenticate the secure key, wherein the authentication comprises to determine whether the secure key matches with a secure key that has been distributed to the client device in a resource having an application-specific format, which application-specific format corresponds to the information management system.

According to a seventh aspect, there is provided a method, comprising transmitting from an information management system a resource to a client device, said resource having an application-specific format corresponding to the information management system, wherein the resource contains at least one of the following data: a secure key for accessing the information management system, a configuration data for a data vault of the information management system, an object being stored in the information management system, a notification relating to a change of an object in the information management system.

According to an eighth aspect, there is provided a server comprising at least one processor, memory including computer program code, the memory and the computer program code configured to, with the at least one processor, cause the apparatus to perform at least the following: transmit a resource to a client device, said resource having an application-specific format corresponding to an information management system, wherein the resource contains at least one of the following data: a secure key for accessing the information management system, a configuration data for a data vault of the information management system, an object being stored in the information management system, a notification relating to a change of an object in the information management system.

According to a ninth aspect, there is provided a computer program product embodied on a non-transitory computer readable medium, comprising computer program code configured to, when executed on at least one processor, cause a system to transmit a resource to a client device, said resource having an application-specific format corresponding to an information management system, wherein the resource contains at least one of the following data: a secure key for accessing the information management system, a configuration data for a data vault of the information management system, an object being stored in the information management system, a notification relating to a change of an object in the information management system.

According to an embodiment, the secure key is used in addition to user credentials for accessing the information management system.

According to an embodiment, the secure key is included in a header of the request.

According to an embodiment, the client device is one of the following: a mobile client, a web client or a desktop client.

According to an embodiment, the resource is a file having an application-specific extension.

According to an embodiment, the resource is a uniform resource locator having an application-specific scheme name.

According to an embodiment, the secure key is stored in the client application accessing the information management system.

### DESCRIPTION OF THE DRAWINGS

In the following, various embodiments of the invention will be described in more detail with reference to the appended drawings, in which

FIG. 1a shows an example of an information management system;

FIG. 1b shows an apparatus according to an embodiment;

FIG. 2 shows a further example of an information management system;

FIG. 3 is a flowchart illustrating a method according to an embodiment;

FIG. 4 is a flowchart illustrating a method according to another embodiment; and

FIG. 5 is a flowchart illustrating a method according to yet further embodiment.

### DESCRIPTION OF EXAMPLE EMBODIMENTS

In the following, several embodiments of the invention will be described in the context of using enterprise information management system in mobile environment. It is to be noted, however, that the invention is not limited to this. In fact, the different embodiments have applications in any environment where secure access to an information management system is required.

Information management system (also known as data management system or content management system), such as enterprise content management systems (ECM), for example, a quality management system (QMS), a document management system (DMS), a customer relationship management system (CRM), can store data (i.e. electronic objects) either statically or dynamically. The present embodiments are disclosed with reference to a dynamic system. It is, however, appreciated that the teachings of the present solution can also be applied to static systems.

In dynamic content management systems, electronic objects do not have a static location in a certain static folder. In dynamic content management systems, folders are so called virtual folders, which are created dynamically based on certain metadata properties. Term “metadata” refers to a set of properties, which set of properties comprises one or more properties having values. A property may have one or more values. An object in a dynamic content management system is a representation of any data. The object may have relationship with (i.e. refers to/is referred by) other objects. The dynamic data management system has a metadata structure that defines semantics for the data. The metadata structure defines metadata for different objects as well as relationships between objects.

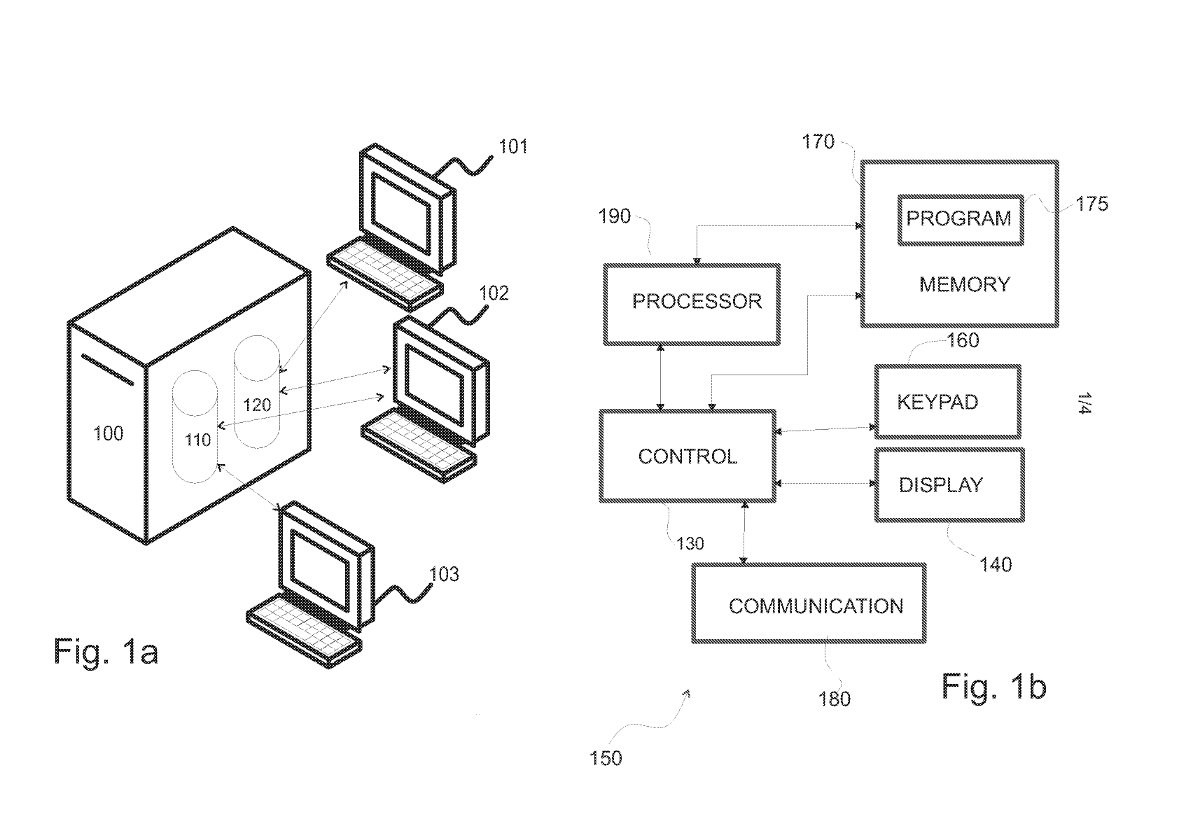

FIG. 1a illustrates an enterprise information management system according to an embodiment. The system comprises at least one server 100 for storing electronic objects. The server may be a so called on-premises server or a cloud server or their combination. The electronic objects may be stored in one or more data vaults 110, 120. One or more client devices 101, 102, 103 can access said at least one server 100 in order to work with the stored electronic objects. For example, a client device may check out an object, wherein a user of the client device may modify the checked-out object. After modification, the user of the client device checks the object in the vault again, wherein the object will be available to other users. The client device may be a personal computer, a mobile device, a laptop, a tablet device, or any computer device. The content stored in the server is used through an application, wherein the application may be universal for all types of client devices, or there can be a client device specific content management application for each device, e.g. a mobile application, a web-based application, a desktop application. In addition, the server device 100 may have its own server application.

An apparatus according to an embodiment is illustrated in FIG. 1b in simplified manner. The apparatus 150 may represent a server device 100 or a client device 101, 102, 103 of FIG. 1a. The apparatus 150 comprises processing means, such as a processor 190 for processing data. The apparatus 150 further comprises memory means, such as a memory 170, storing computer program code 175, applications and various electronic data. The apparatus 150 comprises controlling means, such as a control unit 130, for controlling functions in the apparatus 150. The control unit 130 may run a user interface software to facilitate user control of at least some functions of the apparatus 150. The control unit 130 may also deliver a display command and a switch command to a display 140 to display visual information, e.g. a user interface. The control unit 130 may communicate with the processor 190 and can access the memory 170. Further, the apparatus 150 may comprise input means e.g. in a form of a keypad 160. Yet further, the apparatus 150 comprises various data transfer means, such as a communication block 180 having a transmitter and a receiver for connecting to a network and for sending and receiving information. The communication means can be adapted for telecommunications and/or wide-range and/or short range communication.

When an information management system is used by a client device outside corporate network, there is a need to secure the data from/to the client device. A known solution is to provide VPN (Virtual Private Network) functionality to a client device, said VPN functionality enabling a secure, tunneled connection of a client device to corporate network. The organization may decide to block all network connections from outside the corporate network to the EIM server except for the VPN tunnel. In order to utilize VPN functionality, the user of the client device needs to establish a VPN tunnel by authenticating the tunnel endpoints. This can be based on a username-password combination. The VPN solution may optionally use other additional security factors such as requiring a client certificate or a pre-shared key on a client device or requiring multi-factor authentication when opening the VPN connection. When using VPN functionality with an information management system in mobile environment, the user may have to enter the password every time the user accesses a secure data vault of the information management system. Even though such an operation will ensure secure use of data, from the usability's point of view, such an operation is inconvenient for a user. The requirement of having a VPN client application installed on the client device is also inconvenient to the user.

VPN solutions may use a special communication protocol such as PPTP (Point-to-Point Tunneling Protocol), L2TP (Layer 2 Tunneling Protocol), IPsec (IP Security Architecture), or may use the HTTPS (Hypertext Transfer Protocol Secure) protocol and encapsulate entire network traffic in a TLS/SSL (Transport Layer Security/Secure Sockets Layer) tunnel. The use of non-HTTP/HTTPS protocols has the disadvantage that various corporate and public networks may restrict or prevent such network traffic, which can prevent e.g. a traveling user from establishing a VPN connection to the corporate network.

In addition, today's VPN systems are challenged by the increased variety of client devices that employees want to use to access corporate resources. For example, an organization that uses an on-premises EIM system may face the following challenges if access to EIM is allowed via VPN only:
the additional step of having to open a VPN connection before access is inconvenient;
the VPN client software may not be available for the user's device or operating system;
connecting to the VPN from public networks sometimes fails because of restrictions in those networks;
the VPN connection may randomly terminate in poor network conditions, requiring the user to re-establish the VPN connection.

In practice, requiring a VPN connection as a pre-condition for accessing EIM vaults may prevent some groups of users from accessing the EIM system completely, and will likely deteriorate the user experience of other users, which can result in decreased usage.

Another known solution for protecting a server system from being accessed from unauthorized client device is the use of client certificates. For example, a web server may require the web browser to present a client certificate before being allowed to connect. However, client certificates require specific support by the client devices and operating systems and are thus not suitable for use in an EIM system that must support all client device types and operating systems. Additionally, distributing client certificates to the client devices can be complex and inconvenient.

Yet another known solution for protecting a server system from being accessed from unauthorized client devices is the use of mobile device management (MDM) solutions. An MDM solution may include a server component and a client component which runs on the mobile device or other client device. An MDM solution may provide means for “app containerization” or “app wrapping”, which may mean that the MDM solution allows connections from client applications to the server only via a special communication channel that is managed by the MDM solution. Only “wrapped” or “containerized” applications can communicate with the server. The MDM solution controls which client devices are authorized. This approach can provide the desired security by preventing unauthorized client devices from connecting to the EIM system, but has similar disadvantages as the VPN approach: all client devices must have the MDM solution's client component installed and properly configured, or the EIM system's client application must be specifically “wrapped” or otherwise modified to integrate with the MDM system. An organization using this approach must acquire the MDM system separately, and the EIM system must be compatible with the chosen MDM system in order to be usable. If the MDM system does not support all the client device types or operating system types as the EIM system supports, the use of such MDM solution makes the EIM system inaccessible to some users.

The present embodiments are for avoiding the downsides of the traditional VPN-based, MDM-based or client certificate based approach by providing users secure access to the EIM system without the complexity of VPN, MDM or client certificates. The present embodiments therefore result in a more efficient method, apparatus, computer program product and server. The present embodiments are based on encrypting all network traffic between client devices and the server with HTTPS and using a pre-shared key as an additional shared secret between client devices and the server in addition to user authentication to ensure that only authorized devices can attempt to connect to the system. In other words, a malicious user who has discovered the username and password of an authorized user (e.g. by social hacking) is not able to connect to the EIM system unless the malicious user also has an authorized client device in his/her possession. Any attempts to connect to the EIM system from an unauthorized device would be blocked by the server because the client is not presenting the correct pre-shared key to the server.

VPN-less access to an on-premises EIM system can be enabled to users with an EIM desktop client (e.g. for Microsoft Windows®, Mac OS or Linux), or users using a web browser utilizing the web application part of the EIM system, or users using a mobile app of the EIM system (e.g. for iOS, Android, or Windows Phone).

Client applications for the EIM system (e.g. mobile apps and desktop apps) can securely connect to the EIM vaults without a VPN connection by using an HTTPS connection and a pre-shared key that the application presents in a special HTTP header in each request. Alternatively, the client application may present the pre-shared key in an HTTP cookie or as a query string parameter or by some other means supported by the HTTP/HTTPS protocol. The pre-shared key may be used as an additional layer of authentication; conventional username/password authentication may still be required for the user to be granted access to the EIM vault. Verifying the pre-shared key may occur on the web server level (e.g. in IIS or other web server, or in the web application running on the web server), and verifying the user's credentials (i.e. username and password) may occur on the EIM server level, or both verification checks may occur on the web server level or on the EIM server level.

Additionally, with a desktop client of the EIM system, securely connecting to EIM vaults behind the corporate firewall without a VPN connection may be based on the use of RPC (Remote Procedure Call) over HTTP protocol with SSL/TLS (Secure Socket Layer/Transport Layer Security) encryption. IIS (Internet Information Services) is configured to run a component called RPC over HTTP Proxy that receives the HTTPS traffic from the client and forwards it to the EIM server as RPC communication. An additional layer of security is achieved by configuring IIS to require special authentication for the HTTPS connections, ensuring that only computers that have a pre-shared key installed will succeed in connecting to the EIM server. Verifying the pre-shared key may occur on the IIS level, and verifying the user's credentials (i.e. username and password) may occur on the EIM server level, or both verification checks may occur on the EIM server level.

With a web client of the EIM system, the ability to securely connect to EIM vaults without a VPN connection is based on HTTPS connections and the requirement of a pre-shared key that the web browser must present to the server in order to be granted access. The web browser may present the pre-shared key to the server in a browser cookie, for example, or by other means supported by the HTTP/HTTPS protocol. Verifying the pre-shared key may occur on the web server level (e.g. in IIS or other web server, or in the web application running on the web server), and verifying the user's credentials (i.e. username and password) may occur on the EIM server level, or both verification checks may occur on the web server level or on the EIM server level.

The pre-shared key described in the present application is not the same as an authentication token or authentication cookie used by many known client/server applications, especially web service clients. An authentication token is received from the authentication server when the client application authenticates the user (e.g. the user enters username and password, the authentication server verifies the credentials and upon successful verification, returns an authentication token as a proof of successful authentication). The authentication server may be a separate server (e.g. if using federated authentication) or can be the same server as the EIM server. The pre-shared key described in the present application is used in addition to such authentication token, for a different layer of protection. Anyone who knows the authentication credentials (such as username and password) is able to obtain an authentication token from the authentication server, and thus the authentication token alone does not protect the EIM system from access from unauthorized devices if a user's username and password (or other credentials that the authentication system utilizes) have leaked. The pre-shared key approach described in the present application enables the EIM system to restrict connections to authorized client devices only, independent of the authentication system used by the organization. The client device presents the pre-shared key to the EIM system in addition to the authentication information that logging in to the system requires (if any), such as username and password, other credentials, or an authentication token obtained from a separate authentication server.

In the present embodiments, IIS (Internet Information Service) acts as a proxy server that is configured to verify the pre-shared key prior to allowing the communication to reach the EIM server software. The proxy server may be placed in the DMZ area of the organization's network to provide additional isolation. This way, firewalls can be configured to allow external access to the proxy server only. When there is an additional proxy server with the actual EIM server, there can be two separate DNS (Domain Name Server) names that will lead to the EIM server (e.g. “dnsalias.domain.com” for proxy server and “dnsalias.domain.local” for EIM server). Alternatively, the proxy server and the EIM server may be combined, wherein the combined server is configured to perform the verification of the pre-shared keys.

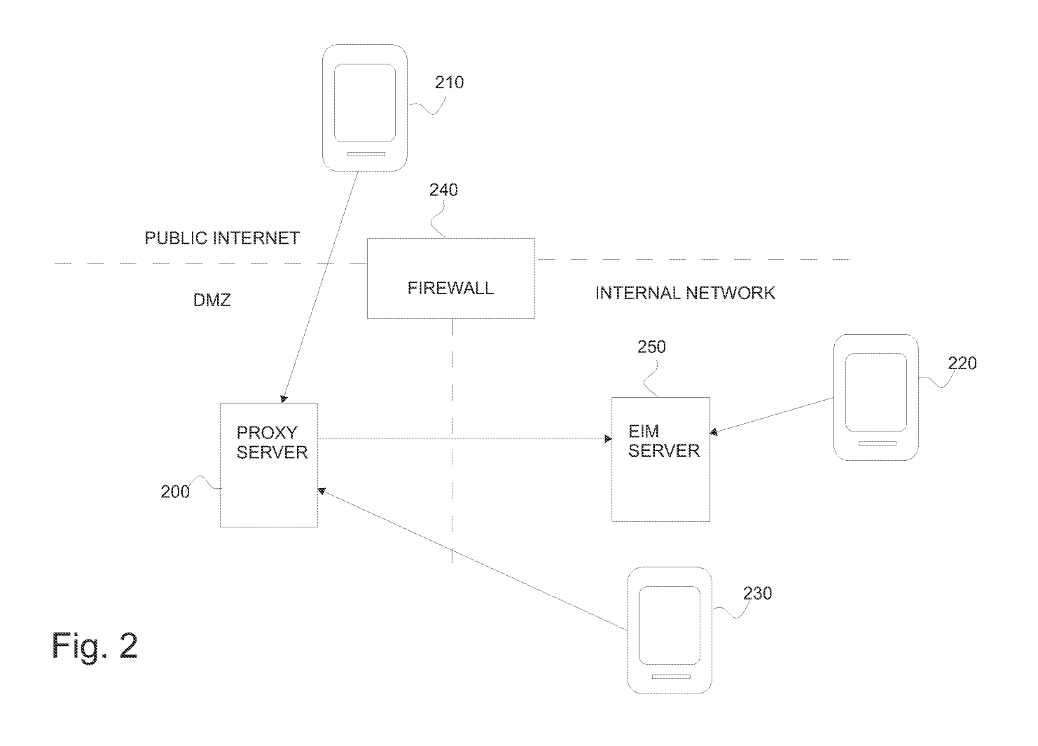

FIG. 2 illustrates an embodiment in which data vaults for an EIM system are accessed without a VPN connection outside the internal network. FIG. 2 shows client devices 210, 220, 230, wherein a client device 210 is using public internet, and client devices 220, 230 are using internal network. A client device 210, 220, 230 can be a mobile client, a web client or a desktop client. FIG. 2 shows an EIM server 250 (for example, such as the one shown in FIG. 1: 100) and a proxy server 200. The EIM server 250 (dnsalias.domain.local) is located in internal network, and the proxy server 200 (dnsalias.domain.com) is located in DMZ (demilitarized zone) connecting the intranet and the internet. FIG. 2 also shows a firewall 240.

According to an example the client devices 210, 230 comprise a mobile application having a pre-shared key, which is verified in the proxy server 200 before allowing the communication to proceed to EIM server 250. Instead of the mobile application, the client devices 210, 230 may comprise a web browser or a desktop application for accessing the information management system. In such example, the web browser or desktop application comprises a pre-shared key. The client device 220 is able to communicate with the EIM server 250 directly, since it is located in the internal network. The EIM server 250 is thus able to authenticate the client device 220 with user's credentials.

To enable the client devices 210, 230 to access the EIM server, the proxy server 200 needs to have a component of the EIM system installed (such as the web application component of the EIM system) or the web server or other proxy server application properly configured for performing the desired checking for the pre-shared key if it occurs on the proxy server level. The proxy server can be the same DMZ computer that acts as the RPC (Remote Procedure Call) over HTTP proxy for the EIM system's desktop client devices. The web application of the EIM system on the proxy server 200 may be configured to require a pre-shared key from client devices 210, 230 that attempt to connect the EIM system. On the proxy server 200, the pre-shared key requirement is enabled by adding appropriate settings to a configuration file or system registry:

For example:

Key name: HKEY_LOCAL_MACHINE\Software\Motive\M-Files\<version>\Server\MFWA
or for site-specific configuration:
Key name: HKEY_LOCAL_MACHINE\Software\Motive\M-Files\<version>\Server\MFWA\Sites\<site-identification>

The values can be added to the keys as follows:

Value name: PresharedKey1;
Value data: <the pre-shared key as a string>
wherein the value for the pre-shared key may be any data, such as a random 64-character key string. The information may be encrypted.

The information management system can be configured to support one or more pre-shared keys. A client device that presents any one of the configured more than one pre-shared keys will be able to access the server. This has the advantage of enabling easy changing of the pre-shared key without causing any downtime for clients. A new pre-shared key can be configured on the server, while clients still use an older pre-shared key for connecting to the system. The new pre-shared key can then be distributed to the clients, and clients can successfully connect with either the older pre-shared key or the new pre-shared key. After some time, the older pre-shared key can be disabled or removed from the server, after which clients will succeed in connecting to the system only if they can present the new pre-shared key.

The pre-shared key is distributed to the users. The pre-shared keys may be EIM server-specific. When connecting to a server comprising the information management system, the client application will present the appropriate pre-shared key to the server, if such pre-shared key is stored in the client application.

Before a client device can use the pre-shared key, the pre-shared key needs to be distributed to the client device. This can be implemented by sending an email message that contains a file having a certain format. When opening such file on the client device, the client device stores the pre-shared key in the client device. For example, a client device having a mobile app for an information management system receives an email, wherein the mobile app stores the pre-shared key from the file for further use when connecting to a specified server. A client device having a web browser for accessing an information management system may also receive an email comprising a file with the pre-shared key and may store the pre-shared key in the web browser in e.g. a browser cookie for further use when connecting to a specified server.

The received file may contain a URL of a certain format, for example:

m-files://setkey?url=https://<servername>&key=<presharedkey>
where “<servername>” is an address for the information management system, such as “dnsalias.domain.com” or “dnsalias.domain.com/virtualdirectoryname”, and where “<presharedkey>” comprises the pre-shared key that has been specified e.g. in the registry on the proxy server. The data in the file can be in any textual or binary format as long as it contains sufficient information for identifying the target system (e.g. server address) and the pre-shared key. The information may be encrypted.

Before sending the file to the user as an email attachment, the file is saved with a name having a specific extension that the EIM system's client applications recognize. For example, the file extension may be “.mflink” and the complete file name can be “keyX.mflink”. The client applications of the EIM system can associate themselves with this file extension, enabling them to open the file when the user performs an action to open the file attachment on a client device.

When a user opens the file in the client device, the device recognizes the file extension (e.g. “.mflink”) and opens the file in the EIM system's client application, enabling the pre-shared key to be stored in the client device by the application. If the device is a mobile device having a mobile app for an information management system, the pre-shared key will be stored in the mobile app. If the device is a client device that uses a web browser for accessing the information management system, the client device sets the pre-shared key to the web browser (e.g. as a browser cookie or local data).

Additionally, the pre-shared key can be distributed to the client devices by means of a URL. The URL may use an application-specific scheme. The client applications of the EIM system can associate themselves with this URL scheme, enabling them to receive the content of the URL when the user performs an action to open or execute the URL on a client device (such as clicking or tapping the URL in an email message or on a web page). Such URL could have e.g. the following format:

m-files://setkey?url=https://<servername>&key=<presharedkey>

Optionally, the EIM system may use the same URL format as the content of the above mentioned email attachment file. Although the URL format and the attachment file format do not need to match, using the same format in both has the advantage of making it easier for users and administrators to create the URL and the attachment file if both means are used in distributing the pre-shared key to the client devices.

For web browser clients, the pre-shared key can be distributed to the client devices by means of an HTTP or HTTPS URL that includes the needed information. Such a URL could have e.g. the following format:

https://<servername>/setkey.ashx?key=<presharedkey>

In the previous, examples for distributing a pre-shared key to a client application have been disclosed. The pre-shared key may be distributed by using a file of certain format and file extension, which file is delivered via email to the client device. The client device recognizes the file extension and is thus able to execute the file due to which the pre-shared key will be stored to the client device. The pre-shared key may also be distributed by using a URL of a certain format and delivering the URL to the client device in e.g. email message body or by making it available on a web page that is accessible to the client device. Any other means for delivering the file or the URL to the client device may be utilized as well. Additionally, it is possible to provide means for the user to explicitly store the pre-shared key on the client device, such as allowing the user to store the pre-shared key in a configuration file or system registry. In such case, the delivery of the pre-shared key to the user of the client device need not be electronic: it is also possible to tell the pre-shared key to the user verbally or in writing and have the user perform actions on the client device to store the pre-shared key.

In addition to the pre-shared keys, also other data can be delivered by means of the special file or application-specific URL format. This provides a simple and effective means for configuring a client application such as a mobile app by sending the user via email a file with an application-specific extension or including a URL string in an application-specific URL format in the body of an email message or SMS message. For example, when the pre-shared key is distributed at the time the EIM vault is built up, the application specific file can also contain configuration data for the data vault, e.g. address information such as a server address or vault identification information. It is appreciated that such file or URL format is a useful way to send data via email, because different operating systems support and different applications are able to associate themselves with either an application-specific extension such as “.mflink” or “.myapp” or an application-specific URL scheme such as “m-files://” or myapp://”. This enables the client application to receive the content of the file or URL and perform any action based on the file or URL.

For example, the following URL with an application-specific scheme could be sent to a user of an EIM client application via email, SMS, or other communication channel in order to configure the EIM client application to establish a connection to an information repository to which the user has not previously connected to:

m-files://addvault?server=https://myserver.com&vault=MyVault&key=secret

As another example, the following URL with an application-specific scheme could be sent to a user of an EIM client application via email, SMS, or other communication channel in order to configure the EIM client application to avoid data connections if the mobile device running the application is using a roaming data connection:

m-files://configure?avoidroamingdata=true

The same or similar information could also be sent as a file attachment in an email message, the file attachment having an application-specific file extension (e.g., “.mflink” or “.myapp”), which the application is registered to handle.

In addition to the above, the special file or application-specific URL format can be used for delivering links to documents or other objects in an EIM system to a user of a mobile app. For example, an EIM system may send notifications of new documents or other interesting objects, or new task assignments, to a user of a mobile client app of the EIM system via email, SMS, or other communication channel. The notification message may contain a link or links to the relevant objects in the EIM system as URLs in an application-specific URL format (using an application-specific URL scheme) or the same or similar information as an attachment file in an application-specific format with an application-specific extension that the mobile app is registered to handle.

For example, an EIM system may send a notification email message to a user, including the following information in the body of the message:

A new document “Proposal for ESTT Corportation.docx” has been created. Click on the following link to access the document:

m-files://open?vault=MyVault123&object=119387

Clicking on the link on the message on a mobile device will cause the information in the link to be passed to the application that has registered itself for that URL scheme, and the application can then execute the appropriate action such as searching for the identified object in the EIM system and presenting the object to the user on the application's screen.

As another example, an EIM system may send a notification email message to a user, including the following information in the body of the message:

You have a new task assignment “Approve this invoice”. Click on the following link to view and complete the assignment:

m-files://task?vault=MyVault123&task=77ads35k

Using an application-specific URL format (with an application-specific URL scheme) in the body of an email message or SMS message has the benefit of being functional in mobile apps across different platforms (e.g., iOS, Android, Windows Phone) as well as in desktop applications (e.g., Microsoft Windows, Apple Mac OS X).

By the present embodiments, a secure connection to a vault is established automatically without a VPN connection. The present solution proposes a two-factor authentication that is formed of user name-password combination and a pre-shared key. Such a two-factor authentication enables secure connection for each client type (web-based client, mobile client, desktop client) for using data in an information management system ensuring that only client devices that have the pre-shared key can connect to the system.

The present embodiments are based on an idea where a pre-shared key is provided for client device, and when accessing the data vault, the client device transmits the pre-shared key to a server as for additional security. The pre-shared key can be required in all data transfer between the client and the server, in which the server would reject any requests that do not include the pre-shared key or other piece of data derived from the pre-shared key. Alternatively, the pre-shared key may be required only in certain requests that are required in order to establish a connection between the client and the server, such as requests related to logging in to the system, in this example, the server would reject any login requests that do not include the pre-shared key or other piece of data derived from the pre-shared key.

In practice, at a time the user aims to access a data vault of an information management system, the user selects to open the vault from a user interface of the information management system application. As a response to the selection, the user is requested a username and a password. In addition to the username and password, the pre-shared key that corresponds to the vault's server is automatically delivered to the server by the client application. After the access has been granted, any request from a user to a server is supplemented with the pre-shared key. When the user accesses another data vault that is located on a same server, the user does not necessarily have to enter the username and password to the server, but the communication is still secured with the pre-shared key. If the other data vault is located on a different server, an access is granted as a response to a correct username and password combination together with a pre-shared key that corresponds to the other server.

The pre-shared key is a shared secret known by both a client application and the server and enables the server to ensure that the client device that attempts to connect to the EIM system can be allowed access (provided that the usual user authentication steps succeed as well). In its simplest form, the pre-shared key can be included as such in the requests from the client device to the server (e.g., if the pre-shared key is “mysecret123”, each request could contain the string “mysecret123” in an HTTP header). Because the communication between the client device and the server uses the secure HTTPS protocol, the communication is encrypted and thus the secret cannot be seen by unauthorized parties. The advantage of this approach is that the mechanism can be easily used in all client device types and all programming languages and technologies, without requiring any application-specific libraries or cryptographic technology.

In some cases the inclusion of the pre-shared key in itself in the requests from the client device to the server may not be desirable (e.g., if the organization wants to protect itself from the possibility of HTTPS protocol attacks where an attacker could decrypt the encrypted HTTPS traffic between the client and the server and thus uncover the pre-shared key). In such cases the EIM system can be configured to require derived data instead of the pre-shared key itself in the requests. All client applications need to be capable of producing the derived data, and the server must be able to verify that the derived data has been produced by someone that with high certainty has knowledge of the actual pre-shared key. For example, a hash function such as SHA could be used to produce derived data from the pre-shared key. The data can be “salted” by something that both the client and the server know for additional security (like the server's name or the users name). Additionally, by salting the data with time-specific data such as the current date or hour, the derived data becomes even more secure as anyone who could uncover the derived data at a specific time would not be able to permanently use the derived data because it would become invalid soon as time passes. Other approaches for increasing the security of the pre-shared key or the derived data can be used as well. They have the advantage of increasing the security, but have the disadvantage of making the implementation of client applications more complicated. For example, an application-specific library or some cryptographic technology could be required at the client application. In general, the present invention aims at providing simple and secure connectivity between various client applications and the EIM server without requiring a VPN connection. In the typical scenario, including the pre-shared key itself in the client-server requests is a sufficient and appropriate solution because of its simplicity and device independence because HTTPS encryption is typically sufficient for securing the pre-shared key.

The various embodiments may provide advantages. The VPN-less access option offers a good balance of simplicity, device-independence and security, and enables the organization to quickly provide mobile and traveling users with convenient access to the organization's EIM vaults.

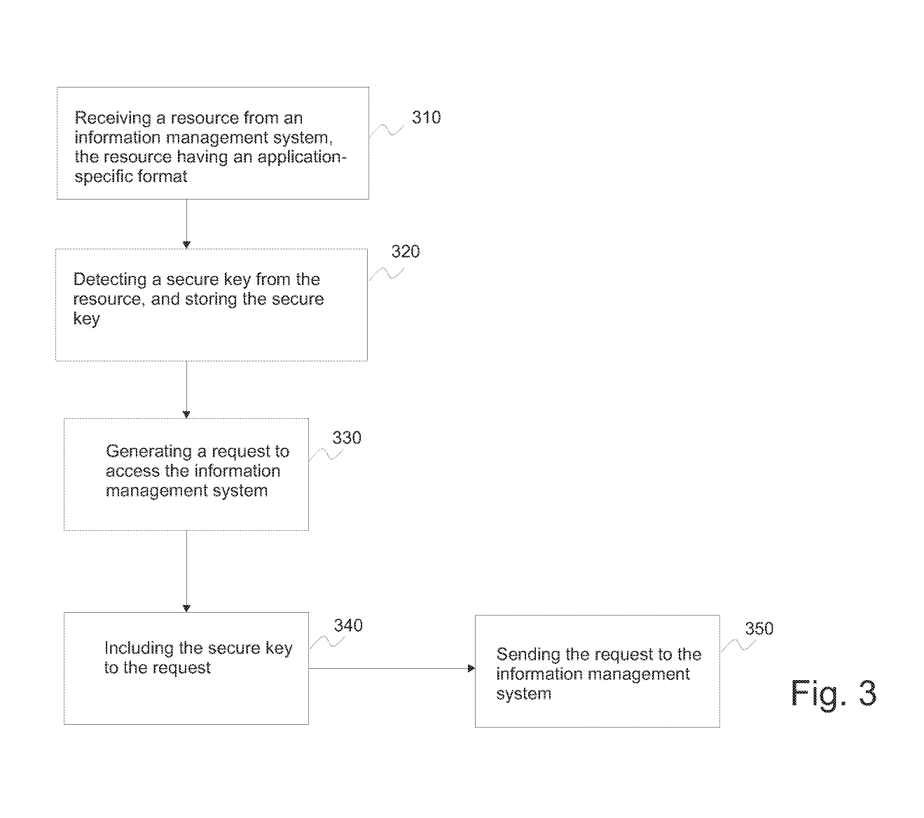

FIGS. 3 to 5 illustrate various embodiments of a method. A method according to an embodiment, shown in FIG. 3, comprises receiving 310 a resource from an information management system, the resource having an application-specific format; detecting a secure key from the resource, and storing the secure key 320; generating a request to access the information management system 330, including the secure key to the request 340 and sending the request to the information management system 350. It is appreciated that time can pass between steps 320 and 330.

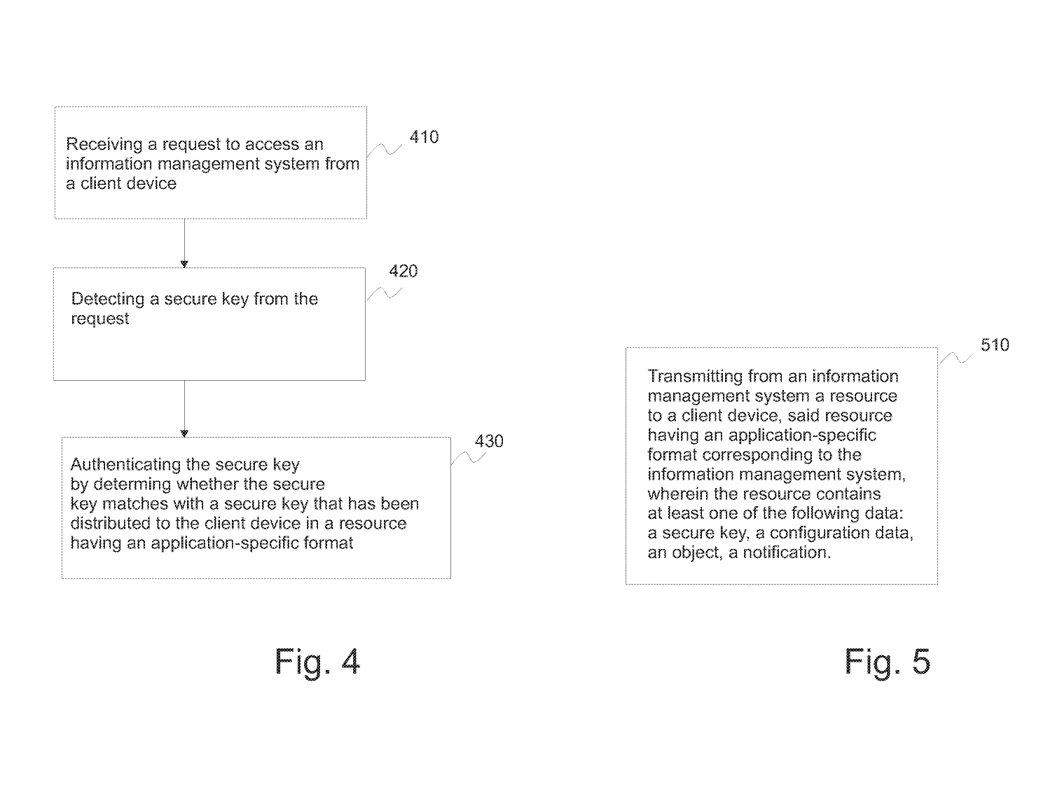

A method according to an embodiment, shown in FIG. 4, comprises receiving a request to access an information management system from a client device 410; detecting a secure key from the request 420; authenticating the secure key by determining whether the secure key matches with a secure key that has been distributed to the client device in a resource having an application-specific format 430. A method according to an embodiment, shown in FIG. 4, comprises Transmitting from an information management system a resource to a client device, said resource having an application-specific format corresponding to the information management system, wherein the resource contains at least one of the following data: a secure key, a configuration data, an object, a notification.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is apparent that the present invention is not limited solely to the above-presented embodiments, but it can be modified within the scope of the appended claims.

1. A method, comprising:
generating a request to access an information management system;
including user credentials and a secure key to the request, wherein the secure key has been obtained from a resource having an application-specific format, which application-specific format corresponds to the information management system; and
sending the request.

2. (canceled)

3. The method according to claim 1, wherein the secure key is included in a header of a request.

4. The method according to claim 1, wherein the method is implemented in a client device being one of the following: a mobile client, a web client or a desktop client.

5. The method according to claim 1, wherein the resource is a file having an application-specific extension.

6. The method according to claim 1, wherein the resource is a uniform resource locator having an application-specific scheme name.

7. The method according to claim 1, wherein the secure key has been stored in the client application accessing the information management system.

8. An apparatus comprising at least one processor, a non-transitory memory including computer program code, the memory and the computer program code configured to, with the at least one processor, cause the apparatus to perform at least the following:
generate a request to access an information management system;
include user credentials and a secure key to the request, wherein the secure key has been obtained from a resource having an application-specific format, which application-specific format corresponds to the information management system; and
send the request.

9. (canceled)

10. The apparatus according to claim 8, further comprising computer program code to cause the apparatus to include the secure key in a header of the request.

11. The apparatus according to claim 8, wherein the apparatus is one of the following: a mobile client device, a web client device or a desktop client device.

12. The apparatus according to claim 8, wherein the resource is a file having an application-specific extension.

13. The apparatus according to claim 8, wherein the resource is a uniform resource locator having an application-specific scheme name.

14. The apparatus according to claim 8, further comprising computer program code to cause the apparatus to store the secure key in the client application accessing the information management system.

15. A computer program product embodied on a non-transitory computer readable medium, comprising computer program code configured to, when executed on at least one processor, cause an apparatus to:
generate a request to access an information management system;
include user credentials and a secure key to the request, wherein the secure key has been obtained from a resource having an application-specific format, which application-specific format corresponds to the information management system; and
send the request.

16. A method, comprising:
receiving a request to access an information management system from a client device;
detecting user credentials and a secure key from the request;
authenticating the secure key, wherein the authentication comprises
determining whether the secure key matches with a secure key that has been distributed to the client device in a resource having an application-specific format, which application-specific format corresponds to the information management system.

17. A server comprising at least one processor, a non-transitory memory including computer program code, the memory and the computer program code configured to, with the at least one processor, cause the apparatus to perform at least the following:
receive a request to access an information management system from a client device;
detect user credentials and a secure key from the request;
authenticate the secure key, wherein the authentication comprises
to determine whether the secure key matches with a secure key that has been distributed to the client device in a resource having an application-specific format, which application-specific format corresponds to the information management system.

18. A computer program product embodied on a non-transitory computer readable medium, comprising computer program code configured to, when executed on at least one processor, cause a system to:
receive a request to access an information management system from a client device;
detect user credentials and a secure key from the request;
authenticate the secure key, wherein the authentication comprises
to determine whether the secure key matches with a secure key that has been distributed to the client device in a resource having an application-specific format, which application-specific format corresponds to the information management system.

19. A method, comprising:
transmitting from an information management system a resource to a client device, said resource having an application-specific format corresponding to the information management system, wherein the resource contains at least one of the following data: a secure key for accessing the information management system with user credentials, a configuration data for a data vault of the information management system, an object being stored in the information management system, a notification relating to a change of an object in the information management system.

20. The method according to claim 19, wherein the client device is one of the following: a mobile client, a web client or a desktop client.

21. A server comprising at least one processor, a non-transitory memory including computer program code, the memory and the computer program code configured to, with the at least one processor, cause the apparatus to perform at least the following:
transmit a resource to a client device, said resource having an application-specific format corresponding to an information management system, wherein the resource contains at least one of the following data: a secure key for accessing the information management system with user credentials, a configuration data for a data vault of the information management system, an object being stored in the information management system, a notification relating to a change of an object in the information management system.

22. A computer program product embodied on a non-transitory computer readable medium, comprising computer program code configured to, when executed on at least one processor, cause a system to:
q-transmit a resource to a client device, said resource having an application-specific format corresponding to an information management system, wherein the resource contains at least one of the following data: a secure key for accessing the information management system with user credentials, a configuration data for a data vault of the information management system, an object being stored in the information management system, a notification relating to a change of an object in the information management system.
